(19) United States
(12) Patent Application Publication
(10) Pub. No.: US 2011/0255512 A1
(43) Pub. Date: Oct. 20, 2011

(54) SYSTEM AND METHOD OF CONTROLLING TRANSMISSION OF ADAPTIVE MEDIA IN PERFORMING HANDOVER BETWEEN HETEROGENEOUS ACCESS NETWORKS

(75) Inventors: Kyoung-Hee Lee, Daejeon (KR); Won Ryu, Daejeon (KR); Bong-Tae Kim, Daejeon (KR)

(73) Assignee: Electronics and Telecommunications Research Institute, Daejeon (KR)

(21) Appl. No.: 13/141,617

(22) PCT Filed: Dec. 3, 2009
(86) PCT No.: PCT/KR2009/007185

§ 371 Date: Jun. 22, 2011

(30) Foreign Application Priority Data
Dec. 22, 2008 (KR) 10-2008-0131620
Apr. 24, 2009 (KR) 10-2009-0035976

(51) Int. Cl. H04W 36/00; H04W 4/00

(52) U.S. Cl. 370/331

(57) ABSTRACT

A system and method of controlling transmission of adaptive media over handover performed between heterogeneous networks are disclosed. When a mobile terminal moves, it detects the necessity of handover between the heterogeneous networks, determines a target network to which it may perform handover, and transmits handover information to an adaptive media server that controls a transmission rate of adaptive media to previously inform about the handover. Then, the adaptive media adjusts a transmission rate of the adaptive media by using the received handover information, and when the mobile terminal performs handover to the target network, it can receive the adaptive media from the adaptive media server. Accordingly, when the mobile terminal using a real time multimedia service in a wireline/wireless environment in which various accessing techniques are integrated performs handover between heterogeneous networks, a change in quality of experience (QoE) sensed by subscribers due to the handover can be reduced.

### TECHNICAL FIELD

The present invention relates to adaptive media transmission controlling for handover between heterogeneous access networks and, more particularly, to a system and method of controlling transmission of adaptive media when a terminal, which is currently using a real time multimedia service, performs handover between heterogeneous access networks in a wireline/wireless environment in which various accessing techniques are integrated.

### BACKGROUND ART

In general, a scalable video coding (SVC) technique represented by MPEG-4 Part AVC (Audio/Video Codec) in an image compression technology is a coding/decoding processing technique for generating and reproducing contents supported to allow for providing an environment-adaptive service to various transmission networks and various reception terminals through a single media stream.

The SVC technique uses a method of multi-layered images, each having a different spatial scalability (i.e., different image resolution), a temporal scalability (i.e., a frame rate per unit time), or a quality scalability (i.e., a compression loss rate of each frame), and transmitting combinations of layers fitting a state of the capability (or capacity) or communication quality of terminals.

For such an environment-adaptive media service, a monitoring technique to observe a change in various network QoS (Quality of Service) parameters (i.e., bandwidth, delay, packet loss rate, etc.) and device parameters (i.e., access type, buffer size, resolution, etc.) of terminals and a signaling technique for transferring such change state to a streamlining server, as well as the coding/decoding technique for generating and reproducing the SVC contents, are required. In addition, a SVC contents server needs to have a technique of extracting a SVC bit stream fitting a situation to transmit a stream providing optimum quality according to a network and terminal state. The related art SVC supporting frameworks have in common in that they include a server supporting such technique and a functional element for monitoring a terminal and network situation.

However, the conventional monitoring technique used for controlling an adaptive media transmission is based on a scheme in which an application layer and a session layer mainly monitor data transmitted and received between a server and a client to extract a network QoS parameter. Thus, a point of time at which the parameters extracted thusly are reflected for controlling transmission of an SVC stream comes after a factor degrading transmission quality such as a radio link disconnection, handover, or the like, is already generated. Thus, the conventional monitoring technique cannot avoid a temporary degradation of quality of experience (QoE) until such time as adaptive controlling is made on media transmission. Such situation-reactive method has a problem in that the application and session layers cannot accurately detect or predict a link layer (L2) or an IP layer (L3) communication connection situation.

In addition, the adaptive media transmission control technique which has been largely used corresponds to the situation-reactive method in which a transmission rate is mainly controlled according to an E2E quality monitoring results at the application layer, and with such method, it is difficult to quickly and flexibly cope with a change in a rapid communication quality due to handover performed by a terminal between heterogeneous networks.

### DISCLOSURE OF INVENTION

### Technical Problem

The present invention has been made to solve the foregoing problems of the related art and therefore an aspect of the present invention is to provide a system for controlling a transmission of adaptive media capable of minimizing a change in quality of experience (QoE) of a real time multimedia service for a subscriber on the move in a wireline/wireless environment in which various access techniques are integrated, and a method for controlling a transmission of adaptive media in performing handover between heterogeneous access networks in the system.

Another aspect of the present invention is to provide a method for flexibly controlling transmission of adaptive media by providing terminal handover state information that can be quickly detected by a network layer to an application layer in an adaptive media transmission controlling system.

### Solution to Problem

According to an aspect of the present invention, there is provided a method for controlling a transmission of adaptive media in performing handover between heterogeneous access networks by using a host-based IP mobility control method in an adaptive media transmission controlling system, the method including: when a mobile terminal moves, detecting, by the mobile terminal, the necessity of performing of handover between the heterogeneous access networks, and searching adjacent networks; determining, by the mobile terminal, a target network to which the mobile terminal is to perform handover, among searched adjacent networks; transmitting, by the mobile terminal, handover information to an adaptive media server to allow the adaptive media server to adjust a transmission rate of adaptive media by using the handover information; performing, by the mobile terminal, handover to the target network; and receiving, by the mobile terminal, adaptive media with the adjusted transmission rate from the adaptive media server.

According to another aspect of the present invention, there is provided a method for controlling a transmission of adaptive media in performing handover between heterogeneous access networks by using a network-based IP mobility control method in an adaptive media transmission controlling system, the method including: when a mobile terminal moves, detecting, by the mobile terminal, the necessity of performing of handover between the heterogeneous access networks, and searching adjacent networks; determining, by the mobile terminal, a target network to which the mobile terminal is to perform handover, among searched adjacent networks; performing handover of a link layer, by the mobile terminal, from a currently accessed network to the target network; initiating, by a point of attachment (PoA) of the target network, an IP handover procedure in association with a mobility control node within a core network; transmitting, by the mobility control node within the core network, handover information to an adaptive media server to allow the adaptive media server to adjust a transmission rate of adaptive media by using the handover information; and receiving, by the mobile terminal, adaptive media with the adjusted transmission rate from the adaptive media server.

According to another aspect of the present invention, there is provided a mobile terminal including: a mobility controller configured to perform a layer 2 or layer 3 (L2/L3) function, predict handover and determine a target network, initiate a handover procedure, and transfer handover information; and an adaptive media client unit configured to perform a function of an application layer, and transmit the handover information received from the mobility controller to an adaptive media server that controls a transmission rate of adaptive media.

### Advantageous Effects of Invention

According to exemplary embodiments of the invention, media can be effectively adapted over handover of a mobile terminal, and QoE of a media service with respect to the mobile terminal can be improved. In addition, in controlling a transmission rate of media fitting a communication environment such as SVC and the like, a change in a rapid communication quality due to handover of the mobile terminal between heterogeneous access networks can be quickly and flexibly coped with.

### BRIEF DESCRIPTION OF DRAWINGS

FIG. 1 illustrates an outline of an adaptive media transmission method employing a host-based IP mobility control scheme according to an exemplary embodiment of the present invention.

FIG. 2 illustrates an outline of an adaptive media transmission method employing a network-based IP mobility control scheme according to an exemplary embodiment of the present invention.

FIG. 3 illustrates a step of reserving/allocating resources in advance with respect to a target network in the adaptive media transmission method employing a host-based IP mobility control scheme according to a first exemplary embodiment of the present invention.

FIG. 4 illustrates a step of reserving/allocating resources in advance with respect to a target network in the adaptive media transmission method employing a network-based IP mobility control scheme according to a second exemplary embodiment of the present invention.

FIG. 5 illustrates a step of reserving/allocating resources in advance with respect to a target network in the adaptive media transmission method employing a host-based IP mobility control scheme according to a third exemplary embodiment of the present invention.

FIG. 6 illustrates a step of reserving/allocating resources in advance with respect to a target network in the adaptive media transmission method employing a network-based IP mobility control scheme according to a fourth exemplary embodiment of the present invention.

### MODE FOR THE INVENTION

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

An IP mobility technique such as mobile IP (MIP), proxy MIP (PMIP), and the like, adopted for the 3GPP LTE (long Term Evolution) structure of an Internet engineering task force (IETF) is centered on processing, by a terminal, a handover situation in which the terminal moves routing domains or between heterogeneous access networks. In addition, such IP mobility techniques are evolving in the forming of interworking with L2 layers (i.e., cross-layering) of each access technique to speed up a handover processing procedure or provide a network-based mobility control function. Namely, an L3 mobility technique, among the IP mobility techniques, allows for the quick and accurate detection of a terminal handover situation by using trigger information indicating an L2 layer connection and handover status. In addition, through such L2/L3 cross-layering, the IP mobility techniques allow for the prediction of an access type and characteristics of a target network to which the terminal is to access after performing handover. A media independent handover (MIH), an 802.21 standard of IEEE, is one of the typical techniques proposed for the L2 and L3 cross-layering.

Rather than the method of predicting and detecting a handover situation through the L2/L3 mobility control technique, an exemplary embodiment of the present invention is focused on a method of reflecting information about the thusly detected handover state in the controlling of a transmission of environment-adaptive media such as SVC.

In detail, in an exemplary embodiment of the present invention, information detected or predicted in the L2/L3 layer is intended to be quickly transferred to an application/session layer to proactively control transmission of adaptive media over a handover situation of a mobile terminal. The present invention can be applicable to an environment in which various access networks overlap, but it is assumed that there are two different access networks (or core networks) in the following description of the present invention, for the sake of brevity.

Here, a method of reflecting advance resource reservation request results with respect to a target network to which handover is to be performed by interworking with resource management function elements positioned within a core network or within an access network, in the controlling of a transmission of adaptive media will now be described.

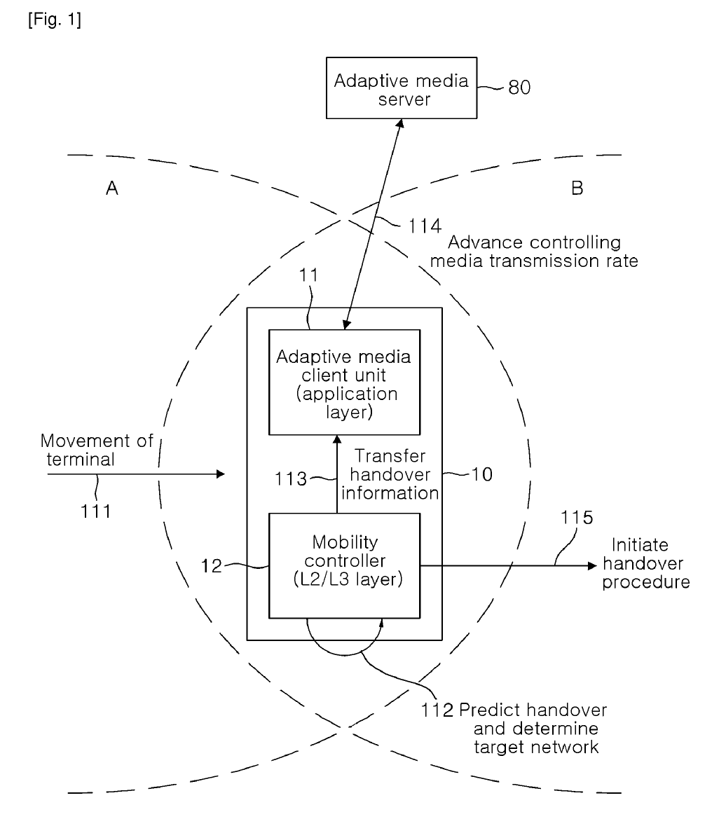

First, the structure of a system for controlling the transmission of adaptive media (referred to as an ‘adaptive media transmission control system’, hereinafter) with respect to performing handover by a terminal between two different access networks (referred to as ‘heterogeneous networks’, hereinafter) will now be described with reference to FIGS. 1, 2, and 3.

The adaptive media transmission control system according to an exemplary embodiment of the present invention includes: point of attachments (PoAs) 20 and 30 connecting with a mobile terminal 10 in heterogeneous networks A and B, a plurality of control nodes 40 to 70 that control the mobility of the mobile terminal 10, and an adaptive media server 80 that controls a transmission rate of a media stream transmitted to the mobile terminal 10.

The detailed functions and operations of each element of the adaptive media transmission control system will now be described through an adaptive media transmission control method.

The adaptive media transmission control method according to an exemplary embodiment of the present invention may be performed by employing an IP mobility control scheme. Thus, the IP mobility control scheme will now be first described. Such IP mobility control scheme may be divided into a host-based IP mobility control scheme and a network-based IP mobility control scheme.

FIG. 1 shows the host-based IP mobility control scheme.

With reference to FIG. 1, the mobile terminal 10 includes an adaptive media client unit 11 for providing an adaptive media application service through interworking with an application layer, and a mobility controller 12 for detecting and processing handover of the terminal through interworking with L2/L3 layers. Here, an example of the mobility control function allowing interworking of the L2/L3 layers may be a combination of the MIH technique, namely, the standard of 802.11 standard of IEEE and a mobile IP (MIP) technique of IETF.

In step 111, when the mobile terminal 10 moves to reach the boundary between the mutually different access networks A and B, in step 112, the mobility controller 12 of the mobile terminal 10 recognizes an upcoming handover situation and determines a target network B to which the mobile terminal 10 is to perform handover, among adjacent networks.

In step 113, the mobility controller 12 of the mobile terminal 10 transfers handover information to the media client unit 11. Here, the handover information is handover prediction information and information regarding the characteristics of the target network B, including, for example, an access type, a bandwidth, an error rate, and the like. In step 114, the adaptive media client unit 11 of the mobile terminal transmits the handover information to the adaptive media server 80 to allow the adaptive media server 80 to control a transmission rate in preparation for a handover situation based on the received handover information.

In step 115, the mobility controller 12 of the mobile terminal 10 starts an L2 and L3 handover procedure.

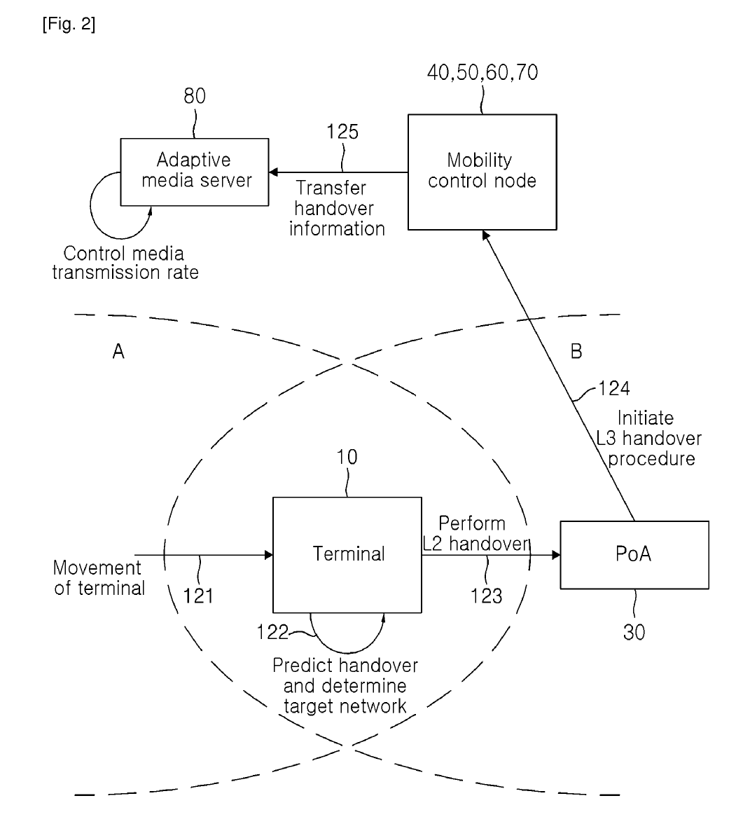

The network-based mobility control scheme will now be described with reference to FIG. 2. Here, the mobile terminal does not have a function of controlling IP mobility. However, for reflecting user preference and fast access controlling, it would be effective for the mobile terminal to have a function of determining a target network to which the mobile terminal is to perform L2 layer handover.

With reference to FIG. 2, when the mobile terminal 10 moves in step 121, the adaptive media client unit 11 of the mobile terminal 10 detects upcoming handover and searches adjacent networks to determine a target network B to which the mobile terminal 10 is to perform handover, among searched adjacent network in step 122.

In step 123, the adaptive media client unit 11 of the mobile terminal 10 performs L2 handover. Accordingly, in step 124, an L3 handover procedure which a point of attachment (PoA) 30 connecting with the mobile terminal 10 follows is started.

Then, in step 125, mobility control nodes (e.g., a local mobility anchor, of a PMIP) 40 to 70 recognize the handover situation of the mobile terminal 10 and transfer mobile terminal handover information and information regarding the characteristics of the target network B to the adaptive media server 80 to inform it about the mobile terminal 10 handover situation. Accordingly, the adaptive media server 80 adjusts a media transmission rate in step 126. Thus, when the mobile terminal 10 completes performing of the L3 handover, the adaptive media server 80 can control a transmission rate of a media stream more quickly than a method of reflecting quality monitoring results at an application layer.

The adaptive media transmission control method by the adaptive media transmission control system according to exemplary embodiments of the present invention will now be described.

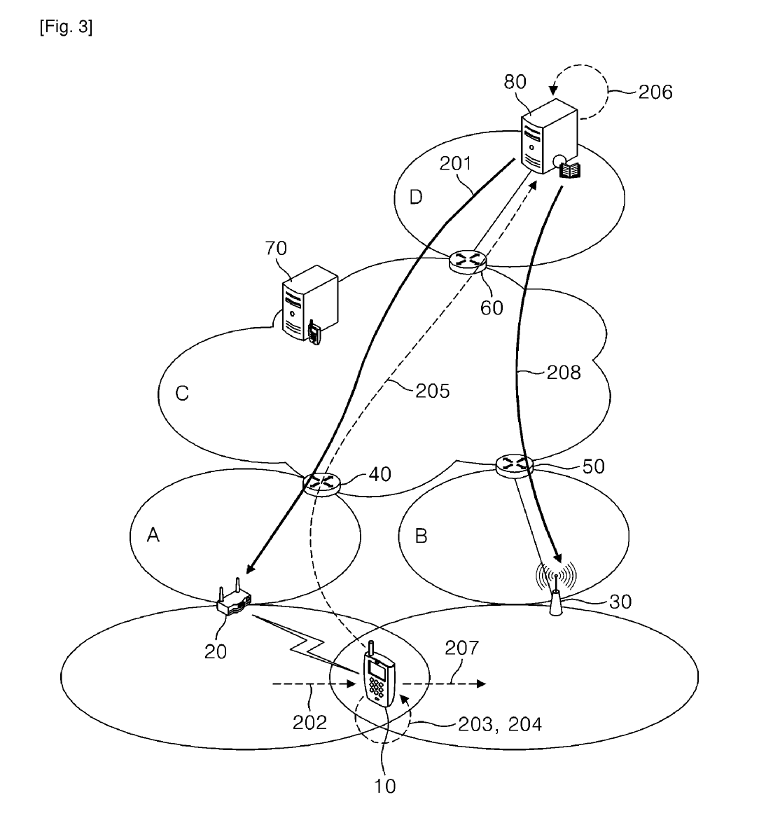

First, the method of controlling a transmission of adaptive media by transferring an upcoming handover situation to an adaptive media application layer in the case that the host-based mobility control scheme is employed according to a first exemplary embodiment of the present invention will now be described with reference to FIG. 3.

With reference to FIG. 3, in step 201, the adaptive media server 80 transmits adaptive media to the PoA 20 connected with the mobile terminal 10. In step 202, when the mobile terminal 20 recedes from the access network A to which the mobile terminal 20 has been connected, the mobile terminal 10 recognizes the necessity of performing handover through a trigger event or the like (e.g., a ‘Link-Going-Down’ event of MIH) of the L2 layer informing that radio link disconnection is at hand. Then, in step 203, the mobile terminal 10 searches for adjacent networks currently accessible, and in step 204, the mobile terminal determines the target network B to which it performs handover among searched candidate networks. Here, in determining the target network B, various factors such as signal strength, a user preference, a network provider policy, and the like, can be checked.

In step 205, the mobile terminal 10 transfers handover information including information regarding the characteristics of the target network B along with the fact that handover is at hand to the adaptive media server 80, thus informing the adaptive media server 80 about the handover in advance. Then, in step 206, the adaptive media server 80 controls an adaptive transmission rate by using the received characteristics information, and in step 207, the adaptive media server transmits adaptive media to the PoA 30 of the target network B. Accordingly, the mobile terminal 10 can receive a media stream which has been adjusted to fit a communication environment of the target network B immediately when it performs handover to the target network B.

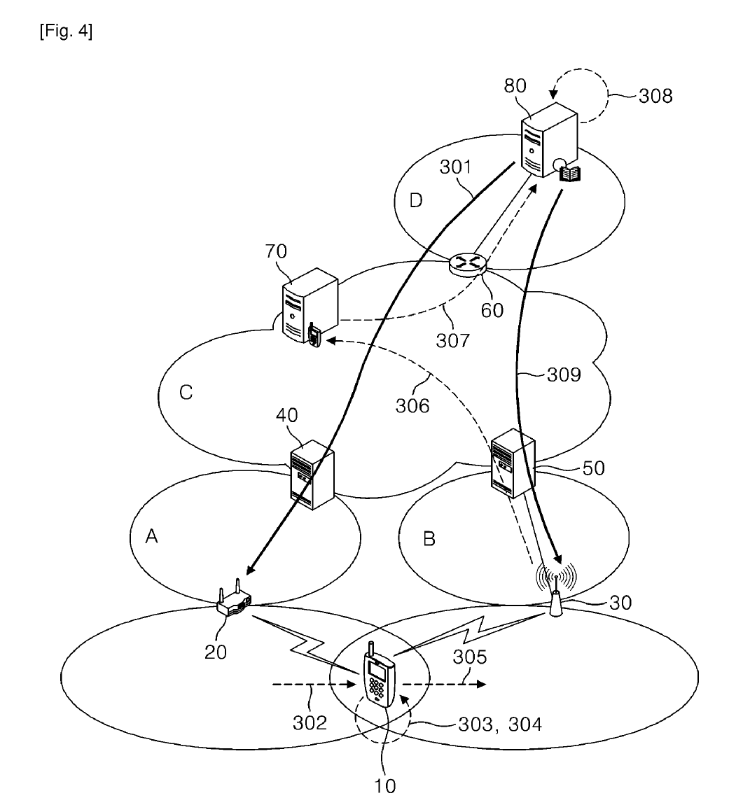

Next, the method of controlling transmission of adaptive media by quickly transferring handover situation to the adaptive media application layer in the case that the network-based mobility control scheme is employed according to a second exemplary embodiment of the present invention will now be described with reference to FIG. 4.

With reference to FIG. 4, in steps 301 to 304, the necessity of performing handover is predicted, adjacent networks are searched, and the handover target network B is determined likewise as in steps 201 to 204 in the first exemplary embodiment of the present invention.

Thereafter, in step 305, the mobile terminal 10 performs only L2 handover to the target network B without associating with the mobility control nodes 40, 50, and 70 according to the characteristics of the network-based control scheme. Then, in step 306, the PoA 30 detects the L2 connection of the mobile terminal 10 and starts performing an L3 handover procedure toward the mobility control node 70 within the core network C via the mobility control node 50 of the target network B, so that the mobility control nodes 40, 50, and 70 within the network can perform the L3 handover. For example, in case of PMIP of IETF, the mobility control nodes 40 and 50 positioned respectively within the access networks A and B may correspond to mobility access gateways (MAGs) and the mobility control node 70 positioned within the core network C may be a local mobility anchor (LMA).

Then, in step 307, the mobility control node 70 transfers the information regarding the handover situation and the information regarding the characteristics of the target network B to the adaptive media server 80, thus informing the adaptive media server 80 about the handover. In this manner, the handover processing between heterogeneous networks is finally performed at the mobility control node 70 positioned in the core network C. Thus, the mobile terminal 10 can receive media (i.e., a media stream) which has been adjusted to fit the communication environment of the target network B immediately after it performs handover.

Unlike the first and second exemplary embodiments of the present invention as described above, an adaptive media system according to third and fourth exemplary embodiments of the present invention includes a resource management node in the target network B. The steps performed until the step of determining the target network to which the mobile terminal is to perform handover in the first and second exemplary embodiments of the present invention are performed in the same manner in the third and fourth exemplary embodiments of the present invention, and a step of reserving and allocating resources in advance with respect to the target network is additionally performed.

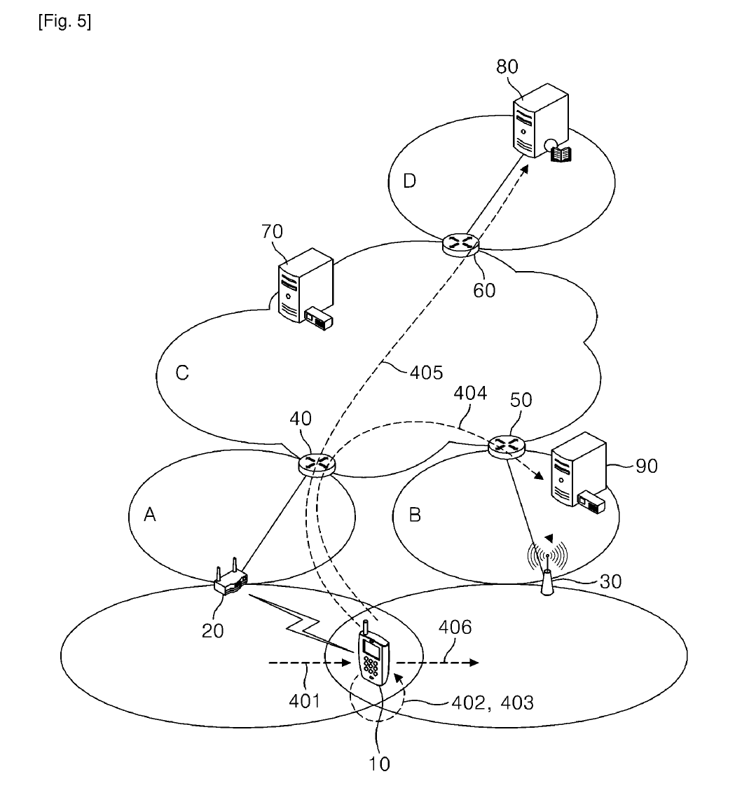

The host-based adaptive media transmission control method in the adaptive media system according to the third exemplary embodiment of the present invention will now be described with reference to FIG. 5.

With reference to FIG. 5, when the mobile terminal 10 moves in step 401, the mobile terminal 10 detects the necessity of performing handover and searches adjacent networks in step 402, and determines the handover target network B in step 403.

In step 404, the mobile terminal 10 requests resource reservation and allocation with respect to the target network B from a resource management node 90 positioned in the target network B in advance. Then, the resource management node 90 may inform only about the result (i.e., granted or denied) of resource reservation and allocation which have been requested by the mobile terminal 10, or reserve and allocate the amount of resource that can be provided as much as possible within the range requested by the mobile terminal 10 and informs the mobile terminal 10 about the reservation and allocation. A typical example of the function of managing such network resources may be a resource admission & control function (RACF) included in a next generation network (NGN) standard of ITU-T.

Thereafter, in step 405, the mobility controller 12 of the mobile terminal 10 includes resource allocation amount information (i.e., resource information regarding the amount of resource that can be guaranteed by the target network B) provided from the resource management node 90 in handover information and transmits the same to the adaptive media server 80, thus previously informing about the handover of the mobile terminal 10. Accordingly, the adaptive media server 80 adjusts a transmission rate of adaptive media. Then, in step 406, the mobile terminal 10 performs L2/L3 handover and then receives the adaptive media transferred from the adaptive media server 80 via the target network B.

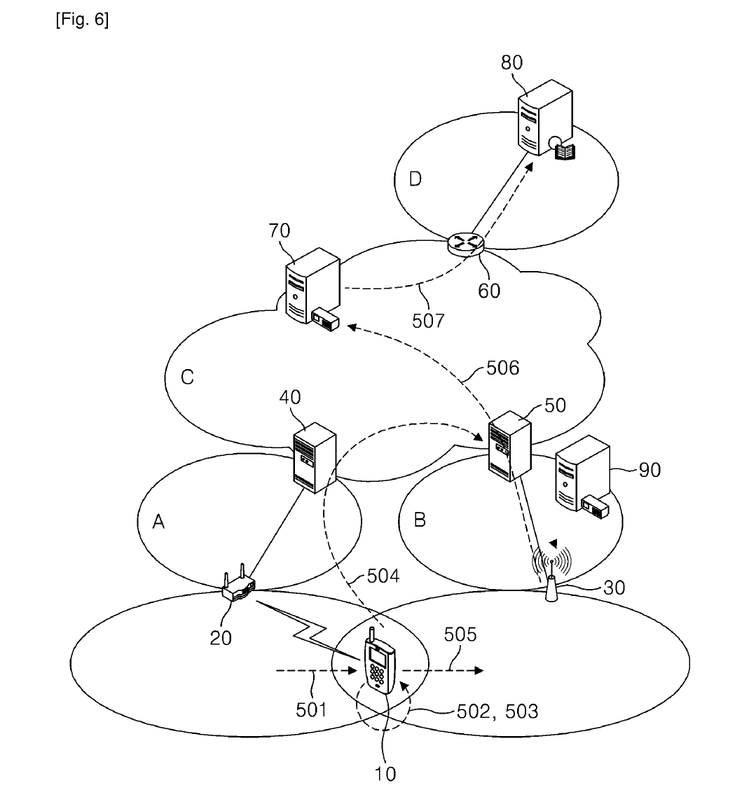

The network-based adaptive media transmission control method in the adaptive media system according to the fourth exemplary embodiment of the present invention will now be described with reference to FIG. 6.

With reference to FIG. 6, in steps 501 to 503, the necessity of performing handover is predicted, adjacent networks are searched, and the handover target network B is determined, likewise as in steps 401 to 403 in the third exemplary embodiment of the present invention.

Thereafter, in step 504, the mobile terminal 10 requests a resource management node 90 positioned in the target network B for resource reservation and allocation with respect to the target network B in advance through the mobility control node 50. Then, the resource management node 90 may inform only about result (i.e., granted or denied) of the resource reservation and allocation which have been requested by the mobile terminal 10, or reserve and allocate the amount of resource that can be provided as much as possible within the range requested by the mobile terminal 10 and informs the mobile terminal 10 about the reservation and allocation through the mobility control node 50.

In step 505, the mobile terminal 10 performs only L2 handover to the target network B without associating with the mobility control nodes 40, 50, and 70 according to the characteristics of the network-based control scheme. And then, steps 506 and 507 are the same as steps 306 and 307 in FIG. 4. In this case, however, the information transferred to the adaptive media server 80 includes the amount of resources which have been reserved and allocated to the target network B as well as the information regarding the handover situation of the mobile terminal 10 and the information regarding the characteristics of the target network B. Then, the adaptive media server 80 adjusts a transmission rate of the adaptive media, and accordingly, the mobile terminal 10 can receive a media stream which has been adjusted to fit the communication environment of the target network B immediately when it performs handover to the target network B.

While the present invention has been shown and described in connection with the exemplary embodiments, it will be apparent to those skilled in the art that modifications and variations can be made without departing from the spirit and scope of the invention as defined by the appended claims.

1. A method for controlling transmission of adaptive media in performing handover between heterogeneous access networks by using a host-based IP mobility control method in an adaptive media transmission controlling system, the method comprising:
when a mobile terminal moves, detecting, by the mobile terminal, the necessity of performing of handover between the heterogeneous access networks, and searching adjacent networks;
determining, by the mobile terminal, a target network to which the mobile terminal is to perform handover, among searched adjacent networks;
transmitting, by the mobile terminal, handover information to an adaptive media server to allow the adaptive media server to adjust a transmission rate of adaptive media by using the handover information;
performing, by the mobile terminal, handover to the target network; and
receiving, by the mobile terminal, adaptive media from the adaptive media server.

2. The method of claim 1, further comprising:
requesting, by the mobile terminal, a resource management node positioned in the target network to reserve and allocate resources with respect to the target network in advance before informing about the handover.

3. The method of claim 2, further comprising:
receiving, by the mobile terminal, information about the amount of allocated resource to be guaranteed after the handover, the results of the advance resource reservation and allocation request, from the resource management node.

4. The method of claim 3, wherein the received resource allocation amount information is included in the handover information and transmitted to the adaptive media server when information regarding the handover is provided previously.

5. A method for controlling transmission of adaptive media in performing handover between heterogeneous access networks by using a network-based IP mobility control method in an adaptive media transmission controlling system, the method comprising:
when a mobile terminal moves, detecting, by the mobile terminal, the necessity of performing of handover between the heterogeneous access networks, and searching adjacent networks;
determining, by the mobile terminal, a target network to which the mobile terminal is to perform handover, among searched adjacent networks;
performing handover of a link layer, by the mobile terminal, from a currently accessed network to the target network;
initiating, by a point of attachment (PoA) of the target network, an IP handover procedure in association with a mobility control node within a core network;
transmitting, by the mobility control node within the core network, handover information to an adaptive media server to allow the adaptive media server to adjust a transmission rate of adaptive media by using the handover information; and
receiving, by the mobile terminal, adaptive media from the adaptive media server.

6. The method of claim 5, further comprising:
requesting, by the mobile terminal, a resource management node positioned in the target network to reserve and allocate resources with respect to the target network in advance before informing about the handover.

7. The method of claim 6, further comprising:
receiving, by the mobile terminal, information about the amount of allocated resource to be guaranteed after the handover, the results of the advance resource reservation and allocation request, from the resource management node.

8. The method of claim 7, wherein the received resource allocation amount information is included in the handover information and transmitted to the adaptive media server, when the mobility control node within the target network informs about the handover.

9. The method of claim 1, wherein the handover information comprises information regarding a handover situation and information regarding the characteristics of the target network.

10. The method of claim 5, wherein the handover information comprises information regarding a handover situation and information regarding the characteristics of the target network.

11. A mobile terminal comprising:
a mobility controller configured to perform a layer 2 or layer 3 (L2/L3) function, predict handover and determine a target network, initiate a handover procedure, and transfer handover information; and
an adaptive media client unit configured to perform a function of an application layer, and transmit the handover information received from the mobility controller to an adaptive media server that controls a transmission rate of adaptive media.

12. The mobile terminal of claim 11, wherein the mobility controller receives information about the amount of allocated resources to be guaranteed after the handover from a resource management node positioned in the target network, includes the resource allocation amount information in the handover information, and transmits the same to the adaptive media server.

13. The mobile terminal of claim 11, wherein the handover information comprises information regarding a handover situation and information regarding the characteristics of the target network.
